(19) United States
(12) Patent Application Publication
(10) Pub. No.: US 2012/0176623 A1
(43) Pub. Date: Jul. 12, 2012

(54) APPARATUS AND METHOD FOR MEASURING CHARACTERISTICS OF MULTI-LAYERED THIN FILMS

(75) Inventors: Chang Yun Lee, Gyunggi-do (KR); Suk Jin Ham, Seoul (KR); June Sik Park, Gyunggi-do (KR)

(73) Assignee: SAMSUNG ELECTRO-MECHANICS CO., LTD., Gyunggi-do (KR)

(21) Appl. No.: 13/076,060

(22) Filed: Mar. 30, 2011

(30) Foreign Application Priority Data
Jan. 11, 2011 (KR) 1020110002753

(51) Int. Cl. G01B 11/02

(52) U.S. Cl. 356/503

(57) ABSTRACT

Disclosed herein are an apparatus and method for measuring characteristics of multi-layered thin films. There is provided an apparatus for measuring characteristics of multi-layered films, including: a light source member irradiating light to a sample formed of the multi-layered thin films; an interference-reflection member splitting light into a first beam for acquiring reference reflection light and a second beam for acquiring sample reflection light, and generating an interference signal when the light shutter is opened, and generating the reflection signal when the light shutter is closed; a sample member scanning and irradiating the sample by the second beam and transferring a support to which the sample is fixed; an interference-reflection light detection member splitting and detecting the intensity of the generated interference signal and reflection signal for each wavelength; and a signal processing member using the intensity of the interference signal for each wavelength and the reflection signal for each wavelength detected from the interference-reflection detection unit to image the multi-layered thin films of the sample, calculating reflectivity, refractive index, and the thickness of the multi-layered thin films. By this configuration, the performance of measuring characteristics of multi-layered thin films can be improved.

### CROSS REFERENCE TO RELATED APPLICATION

This application claims the benefit of Korean Patent Application No. 10-2011-0002753, filed on Jan. 11, 2011, entitled “Apparatus And Method For Measuring Characteristics Of Multi-layered Thin Films” which is hereby incorporated by reference in its entirety into this application.

### BACKGROUND OF THE INVENTION

1. Technical Field

The present invention relates to an apparatus and a method for measuring characteristics of multi-layered thin films.

2. Description of the Related Art

In order to obtain accurate anatomic information and biological tissue in a biomedical engineering field or confinn an internal structure or components of products, an electron microscope method using electron optics such as a transmission electron microscope (TEM) and a scanning electron microscope (SEM) that confirms an inside of a biological tissue or products or tests components thereof by cutting the biological tissue or breaking products has been used.

Recently, research into an optical biopsy for transmitting anatomic information and biological tissue information to a reader without performing a surgical operation has been mainly conducted. The optical method may also be used to confirm or test the internal structure of products.

As an existing nondestructive method of confirming the internal structure of the biological tissue or electronic components or confirming foreign materials, an X-ray nondestructive testing (NDT) method has been mainly used.

In addition, in order to confirm transmittance, reflectivity, and refractive index that are optical characteristics of products in which thin films are configured of several layers, the related art confirms the characteristics of products by using separate spectroscopy.

However, the electron microscope method has a disadvantage of breaking a sample and the X-ray NDT, which is a nondestructive method, performs a complex process such as sample pre-processing before the sample is measured, or the like, and as a result, requires a long time In addition, when the thickness measurement of the multi-layered thin films by the X-rays NDT is several μm to several tens of μm, the measurement can be made. However, it is impossible to measure a thickness of a thinner film than the above-mentioned thickness.

In addition, in order to evaluate the characteristics to be obtained, the electron microscope method and the X-rays NDT may not consistently maintain the measurement positions in the sample by using various methods.

Further, when products are made of a flexible material or a low crystalline material such as an organic polymer material, a high energy measurement method such as X-rays has is a limitation in confirming the internal structure of the products.

Therefore, an apparatus and a method for measuring characteristics of multi-layered thin films capable of more accurately and precisely measuring the internal shapes such as the internal image of multi-layered thin films and the thickness of each multi-layered thin film and the optical characteristics such as reflectivity, transmittance, and refractive index, or the like, with the nondestructive method are urgently needed.

### SUMMARY OF THE INVENTION

The present invention has been made in an effort to provide an apparatus and a method for measuring characteristics of multi-layered thin films capable of measuring an internal structure of the multi-layered thin films and optical characteristics using a nondestructive method by generating interference signals and reflection signals according to the opening and closing of an light shutter and detecting them by splitting them for each wavelength.

According to a preferred embodiment of the present invention, there is provided an apparatus for measuring characteristics of multi-layered thin films, including: a light source member irradiating light to a sample formed of the multi-layered thin films; an interference-reflection member installed on an optical path between the light source member and the sample to split light into a first beam for acquiring reference reflection light and a second beam for acquiring sample reflection light and generating an interference signal due to the overlapping of the reference reflection light reflected from the first beam and the sample reflection light reflected from the second beam when a light shutter is opened and generating the reflection signal due to the sample reflection light from the second beam when the light shutter is closed; a sample member scanning and irradiating the sample so that the second beam is irradiated to the entire sample and transferring a support to which the sample is fixed so that the sample position is changed; an interference-reflection light detection member splitting and detecting the intensity of the generated interference signal and reflection signal for each wavelength; and a signal processing member using the intensity of the interference signal for each wavelength and the reflection signal for each wavelength detected from the interference-reflection light detection member to image the multi-layered thin films of the sample, calculating the reflectivity for each wavelength, the refractive index for each wavelength, and the thickness of each layer of the multi-layered thin films, and controlling the opening and closing of the light shutter and the transfer of the support.

The light source member may be a low coherence light source that is at least one of an (SLD), a femtosecond laser, an ASE, a fiber laser, supercontinuum lighting, and a lamp.

The interference-reflection member may include: a light splitting unit splitting light into the first beam and the second beam; a reference light reflection unit reflecting reference reflection light by receiving the split first beam; and a light shutter opened and closed to permit and interrupt the incidence and the reflection of the split first beam.

The optical splitting unit may be a beam splitter.

The reference light reflection unit may be a mirror.

The sample member may include: a sample scan unit scanning to be irradiated the second beam to the entire sample; a sample loading unit including a sample irradiated with the second beam by the sample scan unit and a support fixed with the sample and movably designed to change the position of the sample; and a sample transfer unit installed at one side of the support and operated to transfer the support up and down, left and right, and in a rotatable manner according to the control of the signal processing member.

The sample scan unit may be configured of a galvanometer mirror that one-dimensionally and two-dimensionally scans the second beam to the sample while repeatedly rotating by a predetermined angle according to a voltage value input by a first mirror and a second mirror using different axes as a rotating axis.

The interference-reflection light detection member may include: a first wavelength splitting unit splitting the intensity of the interference signal and the reflection signal for each wavelength; and a first photodetection unit detecting the intensity of the interference signal for each wavelength and the reflection signal for each wavelength split by the first wavelength splitting unit.

The first photodetection unit may be any one of CCD, PMT, and PIN detectors.

The signal processing member may include: an optical signal processing unit converting the interference signal for each wavelength and the reflection signal for each wavelength detected from the interference-reflectiion light detection member into an electrical signal; an image/calculation unit performing Fourier transform on the intensity of the converted interference signal for each wavelength to acquire the image of the multi-layered thin films of the sample and acquiring the reflectivity from a graph according to the intensity of the converted reflection signal for each wavelength to calculate the refractive index and the thickness of the multi-layered thin film of the sample; and a transfer control unit controlling the opening and closing of the light shutter and controlling the transfer of the support to change the position of the sample.

The apparatus for measuring characteristics of multi-layered thin films may further include a transmission light detection member splitting and detecting the intensity of the transmission signal for each wavelength, the transmission signal being generated by passing the second beam through the sample.

The transmission light detection member may include: a second wavelength splitting unit splitting the intensity of the transmission signal for each wavelength; and a second photodetection unit detecting the intensity of the transmission signal for each wavelength split by the second wavelength splitting unit.

The second photodetection unit may be any one of CCD, PMT, and PIN detectors.

According to a preferred embodiment of the present invention, there is provided a method for measuring characteristics of multi-layered thin films, including: (A) generating light for irradiating light to a sample configured of multi-layered thin films and splitting the generated light into a first beam for acquiring reference reflection light and a second beam for acquiring sample reflection light; (B) splitting and detecting the intensity of an interference signal and a reflection signal for each wavelength by determining whether a control signal for opening a light shutter is present to generate the interference signal due to the overlapping of the reference reflection light reflected from the first beam and the sample reflection light reflected from the second beam when the control signal for opening the light shutter is present and if it is determined that the control signal for opening the light shutter is not present, determining whether a control signal for closing the light shutter is present to generate the reflection signal by the sample reflection light due to the second beam; and (C) acquiring images of the multi-layered thin films of the sample by using the detected intensity of the interference signal for each wavelength and calculating reflectivity, refractive index, and the thickness of the multi-layered thin films of the sample using the detected intensity of the reflection signal for each wavelength.

Step (A) may include: (A-1) generating light for irradiating light to the sample; and (A-2) splitting the generated light into the first beam for acquiring the reference reflection light and the second beam for acquiring the sample reflection light.

Step (B) may include: (B-1) determining whether the control signal for opening the light shutter is present; (B-2) if it is determined that the control signal for opening the light shutter is not present, determining whether the control signal for closing the light shutter is present; (B-3) if it is determined that the control signal for opening the light shutter is present, generating the interference signal due to the overlapping of the reference reflection light reflected from the first beam and the sample reflection light reflected from the second beam; (B-4) if it is determined that the control signal for closing the light shutter is present, generating the reflection signal by the sample reflection light due to the second beam; and (B-5) splitting and detecting the intensity of the generated interference signal and reflection signal for each wavelength.

Step (C) may include: (C-1) performing Fourier transform on the detected intensity of the interference signal for each wavelength to acquire the image of the multi-layer thin films of the sample; and (C-2) acquiring the reflectivity for each wavelength through a graph according to the detected intensity of the reflection signal for each wavelength and applying the acquired reflectivity for each wavelength to Fresnel equations to calculate the refractive index for each wavelength, and calculating the thickness of each layer of the multi-layered thin films of the sample according to a dispersion relationship of the wavelength and the refractive index by using the calculated refractive index for each wavelength.

The method for measuring characteristics of multi-layered thin films may further include: (D) acquiring transmittance by splitting and detecting the intensity of the transmission signal for each wavelength, the transmission signal being generated by passing the second beam through the sample.

Step (D) may include: (D-1) generating a transmission signal by transmission light generated by partially passing the second beam through the sample; (D-2) splitting and detecting the intensity of the generated transmission signal for each wavelength; and (D-3) acquiring the transmittance for each wavelength through a graph according to the detected transmission signal for each wavelength.

### BRIEF DESCRIPTION OF THE DRAWINGS

FIG. 1 is a block diagram showing an apparatus for measuring characteristics of multi-layered thin films according to an exemplary embodiment of the present invention;

FIG. 2 is a configuration diagram of an apparatus for measuring characteristics of multi-layered thin films shown in FIG. 1;

FIG. 3 is a graph showing an example of reflectivity for each wavelength and transmittance for each wavelength detected from first and second photodetection units of the present invention; and

FIG. 4 is a flow chart showing a method for measuring characteristics of multi-layered thin films according to an exemplary embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

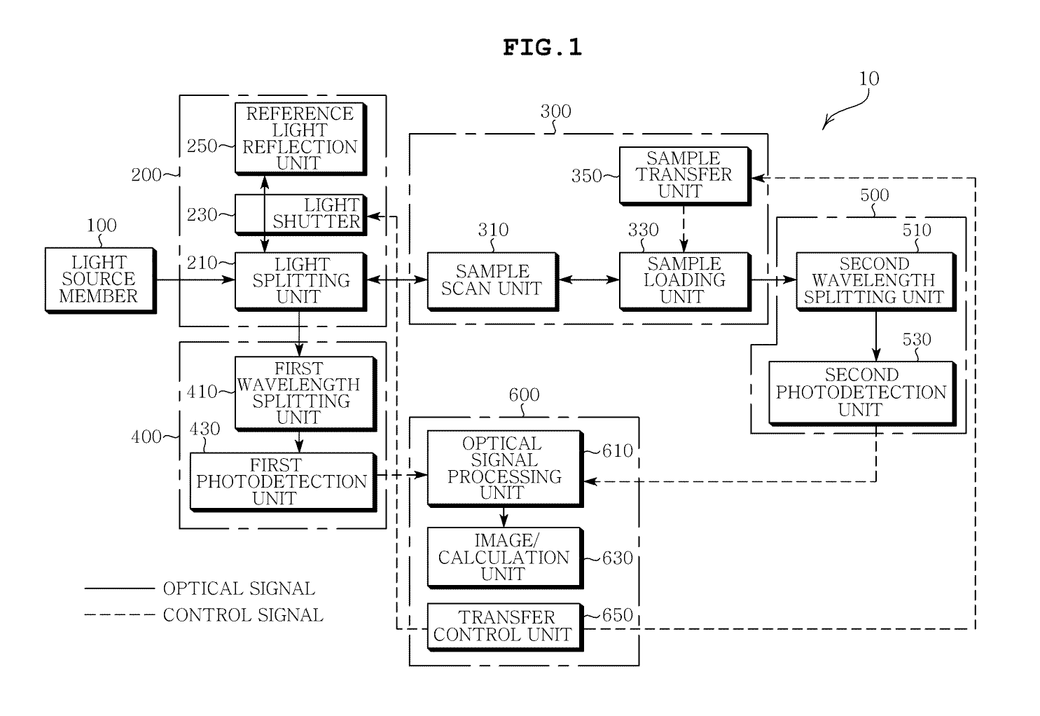

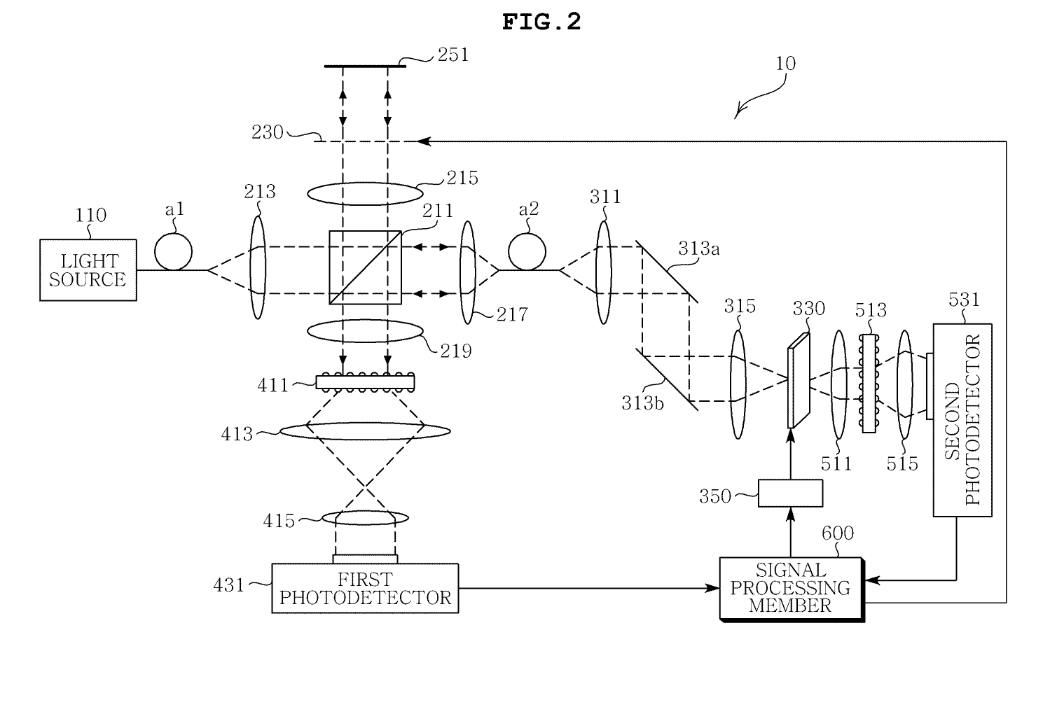

FIG. 1 is a block diagram showing an apparatus for measuring characteristics of multi-layered thin films according to an exemplary embodiment of the present invention and FIG. 2 is a configuration diagram of ari apparatus for measuring characteristics of multi-layered thin films shown in FIG. 1.

Referring to FIGS. 1 and 2, an apparatus 10 for measuring characteristics of multi-layered thin films according to an exemplary embodiment of the present invention may be configured to include a light source member 100, an interference-reflection member 200, a sample member 300, an interference-reflection light detection member 400, a transmission light detection member 500, and a signal processing member 600.

The light source member 100 generates light irradiated to a sample configured of multi-layered thin films. In the exemplary embodiment of the present invention, a low coherence light source 110 in which a coherence length is relatively short is used.

The reason is that it is possible to measure the place of depth in the multi-layered thin films of the sample by the interference when the difference in the optical path length from the light source member 100 to the interference-reflection member 200 and the sample member 300 to be described below is shorter than the coherence length of the light source member 100.

Therefore, the light source member 100 is used as the low coherence light source 110. An example of the low coherence light source 110 may include a super luminescent diode (SLD), a femtosecond laser, amplified spontaneous emission (ASE), a fiber laser, supercontinuum lighting, a light emitting diode (LED) a lamp, or the like.

Light generated from the light source member 100 is incident to the interference-reflection member 200 installed on an optical path irradiated from the light source member 100 to the sample to generate the interference signals and the reflection signals.

The interference-reflection member 200 is configured to include a light splitting unit 210, a light shutter 230, and a reference light reflection unit 250.

As the light splitting unit 210, a polarizing or non-polarizing beam splitter 211 is used, which serves to split the amplitude of incident light. The beam splitter 211 splits the incident light into a first beam for obtaining the reference reflection light and a second beam for obtaining the sample reflection light, respectively.

For example, as shown in FIG. 2, the light splitting unit 210 splits the light input from the light source member 100 into the first beam propagated to the reference light reflection unit 250 and the second beam propagated to the sample of the sample member 300 to be described below, respectively.

The light splitting unit 210 may be configured to further include a first lens 213 installed between the light source member 100 and the light splitter 211 to collect light input from the light source member 100 and make the collected light into parallel light, a second lens 215 installed between the light splitter 211 and the reference light reflection unit 250 to collimate the first beam split from the light splitter 211 to the reference light reflection unit 250, a third lens 217 installed between the light splitter 211 and the sample member 300 to be described below to collect the second beam split from the light splitter 211 to the sample member 300, and a fourth lens 219 installed between the light splitter 211 and the interference-reflection light detection member 400 to be described below to collimate the interference light and the reflection light generated from the light splitter 211 to the interference-reflection light detection member 400.

In addition, a single mode, multi mode, or bundle type of a first optical fiber a1 is connected between the light source member 100 and the first lens 213, thereby making it possible to transfer light.

In this case, as the reference light reflection unit 250, the mirror 251 is used. The mirror 251 is a metallic, dielectric, high-energy, and ultrafast mirror.

In addition, the position of the mirror 251 is fixed or the mirror 251 is installed on a piezoelectric element (PZT) or a transducer, such that it may periodically perform linear motion.

The light shutter 230 may be opened or closed according to the control of the signal processing member 600 to be described below and is installed between the light splitting unit 210 and the reference light reflection unit 250, thereby permitting or blocking the incidence and reflection of the first beam.

When the light shutter 230 is opened, the first beam is incident to the reference light reflection unit 250 to again reflect the reference reflection light from the reference light reflection unit 250 to the light splitting unit 210 and the second beam is incident to the sample of the sample member 300 to again reflect the sample reflection light from each layer of the multi-layered thin films of the sample to the light splitting unit 210.

In this case, the light splitting unit 210 generates the interference signals due to the overlapping of the reference reflection light and the sample reflection light.

When the light shutter 230 is closed, the incidence of the first beam to the reference light reflection unit 250 is blocked not to generate the reference reflection light reflected from the reference light reflection unit 250 to the light splitting unit 210 and the second beam is incident to the sample of the sample member 300 to exist only the sample reflection light reflected from each layer of the multi-layered thin films of the sample in the light splitting unit 210.

In this case, the light splitting unit 210 generates the reflection signal by the sample reflection light.

The sample member 300 may be configured to include a sample scan unit 310, a sample loading unit 330, and a sample transfer unit 350.

The sample scan unit 310 scans the sample so that the second beam input from the light splitting unit 210 is irradiated to all the samples.

The sample scan unit 310 uses a galvanometer mirror that one-dimensionally and two-dimensionally scans the second beam to the sample while repeatedly rotating by a predetermined angle according to a voltage value input by a first mirror 313a and a second mirror 313b using, for example, different axes (for example, an X-axis and a Y-axis) as a rotating axis.

The sample scan unit 310 may be configured to further include a fifth lens 311 installed between the interference-reflection member 200 (for example, a third lens 217) and the sample scan unit 310 (for example, the first mirror 313a configuring the galvanometer mirror) to collect the second beam input from the interference-reflection member 200 and make the input second beam into the parallel light and a sixth lens 315 installed between the sample scan unit 310 (for example, the second mirror 313b configuring the galvanometer mirror) and the sample loading unit 330 to collect the second beam scanned through the sample scan unit 310 to the sample of the sample loading unit 330.

In addition, a single mode, multi mode, or bundle type of a second optical fiber a2 is connected between the interference-reflection member 200 (for example, the third lens 217) and the sample member 300 (for example, the fifth lens 311), thereby making it possible to transfer light.

The second beam scanned through the sample scan unit 310 is incident to the sample loading unit 330, in detail, the sample (not shown) of the sample loading unit 330.

The sample loading unit 330 is configured to include a measurable sample to which the to second beam is irradiated by the sample scan unit 310 and a support movably designed to fix the sample and to change the position of the sample.

In the present invention, the support is a plate structure opened in a direction in which the incident light, that is, the second beam is incident and transmitted.

The sample transfer unit 350 is installed at one side of the support to transfer the support up and down, left and right, and rotatably according to the control signal of the signal processing member 600 to be described below.

As described above, when the second beam split from the light splitting unit 210 is irradiated to the sample of the loading unit 330 through the sample loading unit 330, the sample member 300 again reflects the sample reflection light from the multi-layered thin films having different thickness and materials of the sample to the light splitting unit 210.

In addition, some of the second beam irradiated to the sample transmits through the sample and the transmission light is detected by the transmission light detection member 500 to be described below.

Meanwhile, the intensity of the interference signal and the reflection signal generated from the light splitting unit 210 is detected for each wavelength from the interference-reflection light detection member 400.

The interference-reflection light detection member 400 is configured to include a first wavelength splitting unit 410 and a first photodetection unit 430.

The first wavelength splitting unit 410 splits the input interference signal or reflection signal for each wavelength such as the reflective or transmissive diffractive grating or a prism. For example, as shown in FIG. 2, the firs wavelength splitter 411 is used.

The first wavelength splitting unit 410 may further include a seventh lens 413 installed between the first wavelength splitter 411 and the first photodetector 431 to be described below to collect the interference light and the reflection light split from the first wavelength splitter 411 and an eighth lens 415 collimating the collected interference light and reflection light to the first photodetector 431.

The first photodetection unit 430 detects the intensity of the interference signal and the reflection signal split for each wavelength from the first wavelength splitting unit 410. For example, as shown in FIG. 2, the first photodetector 431 is used.

The intensity of the interference signal for each wavelength detected through the first photodetection unit 430 is transferred to the signal processing member 600 to image the multi-layered thin films of the sample to be described below, thereby obtaining the internal image of the multi-layered thin films of the sample.

In addition, the intensity of the reflection signal for each wavelength detected through the first photodetection unit 430 is transferred to the signal processing member 600 to be described below, thereby obtaining the reflectivity for each wavelength.

An example of the first photodetection unit 430 may include a charge coupled device (CCD) in which an arrangement of pixels has a two-dimensional or one-dimensional array shape, photomultiplier tube (PMT), or PIN detectors, etc.

Meanwhile, the intensity of the transmission signal generated by partially passing the second beam irradiated to the sample of the sample member 300 through the sample is detected for each wavelength from the transmission light detection member 500.

The transmission light detection member 500 is configured to include a second wavelength splitting unit 510 and a second photodetection unit 530.

The second wavelength splitting unit 510 splits the input transmission signal for each wavelength, similar to the reflective or transmissive diffractive grating, a prism, or the like. For example, a second wavelength splitter 513 is used as shown in FIG. 2.

The second wavelength splitting unit 510 may be configured to further include a ninth lens 511 installed between the sample member 300 and the second photodetection unit 530 to collect light transmitting the sample and a tenth lens 515 installed between the second wavelength splitter 513 and the second photodetector 531 to be described below to collect the transmission light split from the second wavelength splitter 513 and transfer the collected light to the second photodetector 531.

The second photodetection unit 530 detects the intensity of the transmission signal split for each wavelength from the second wavelength splitting unit 510. For example, a second photodetector 531 is used as shown in FIG. 2.

The intensity of the transmission signal for each wavelength detected through the second photodetection unit 530 is transferred to a signal processing member 600 to be described later, thereby acquire transmittance for each wavelength.

Similar to the first photodetection unit 430, the second photodetection unit 530 may include a charge coupled device (CCD) in which an arrangement of pixels has a two-dimensional or one-dimensional array shape, photomultiplier tube (PMT), or PIN detectors, etc.

The signal processing member 600 generally controls the apparatus 10 for measuring characteristics of multi-layered thin films and is configured to include an optical signal processing unit 610, an image/calculation unit 630, and a transfer control unit 650.

The optical signal processing unit 610 converts the interference signal, the reflection signal, and the optical signal of the transmission signal for each wavelength detected from the first and second photodetection units 430 and 530 into the electrical signal and transfers the converted electrical signal to the image/calculation unit 630.

The image/calculation unit 630 performs Fourier transform on the intensity of the interference signal for each wavelength, which is converted into the electrical signal, and images it, so as to acquire the internal image of the multi-layered thin films of the sample.

In addition, the image/calculation unit 630 acquires the reflectivity for each wavelength and the transmittance for each wavelength from a graph according to the intensity of the reflection signal for each wavelength and the intensity of the transmission signal for each wavelength that are converted into the electrical signal, respectively.

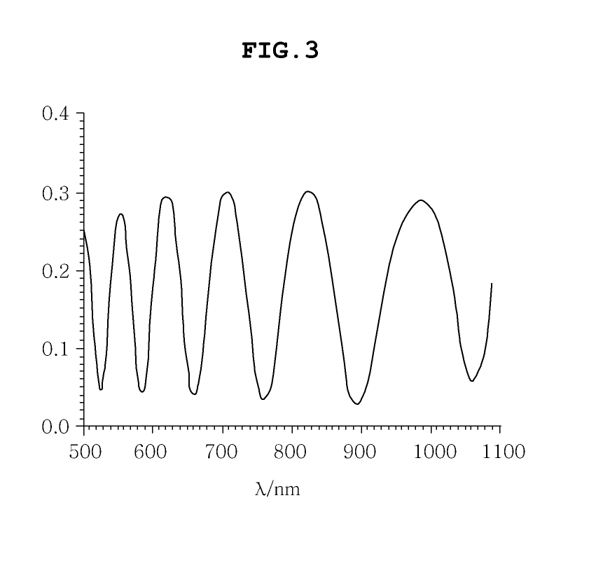

FIG. 3 is a graph showing an example of the reflectivity for each wavelength or the transmittance for each wavelength detected from the first or second photodetection unit of the present invention. An x-axis of the graph shown in FIG. 3 shows the wavelength and a y-axis shows the reflectivity calculated by using the detected intensity of the reflection signal for each wavelength or the transmittance calculated by using the detected intensity of the transmission signal for each wavelength.

The image/calculation unit 630 receives the detected intensity of the reflection signal for each wavelength or the detected intensity of the transmission signal for each wavelength to calculate the reflectivity for each wavelength and the transmittance for each wavelength, thereby making it possible to acquire a graph showing the reflectivity for each wavelength or the transmittance for each wavelength as shown in FIG. 3.

In the graph, it can be appreciated that the reflectivity for each wavelength or the transmittance for each wavelength are periodically changed according to the wavelength.

Next, the image/calculation unit 630 applies the acquired reflectivity for each wavelength and transmittance for each wavelength to Fresnel equations to calculate the refractive index for each wavelength and applies the calculated refractive index for each wavelength to a dispersion relationship (1) of the wavelength and the refractive index to calculate a thickness (d) of each layer of the multi-layered thin films of the sample.

$$d = \frac{1}{2 {n}_{{λ}_{m}} ( \frac{1}{{λ}_{m + 1}} - \frac{1}{{λ}_{m}} )} \qquad ( 1 )$$

Where n represents a refractive index, λ represents a wavelength, λₘ represents an m-th layer among the multi-layered thin films of the sample. λₘ represents a wavelength according to the m-th thin film of the sample, λₘ₊₁ is a wavelength according to the m+1-th thin film of the sample, and n_{λ}_{ₘ} represents a refractive index at a wavelength according to the m-th thin film.

The transfer control unit 650 controls the optical-shutter 230 of the interference-reflection member 200 and the sample transfer unit 350 of the sample member 300.

The light shutter 230 is opened and closed according to the control signal of the transfer control unit 650, thereby making it possible to generate the interference signal (at the time of opening) and the reflection signal (at the time of closing) from the light splitting unit 210.

In addition, the sample transfer unit 350 transfers the sample loading unit 330, in which the sample is loaded, up and down, left and right, and a rotatable manner according to the control signal of the transfer control unit 650, such that it is easy to uniformly irradiate the second beam irradiated through the sample scan unit 310 to the entire sample.

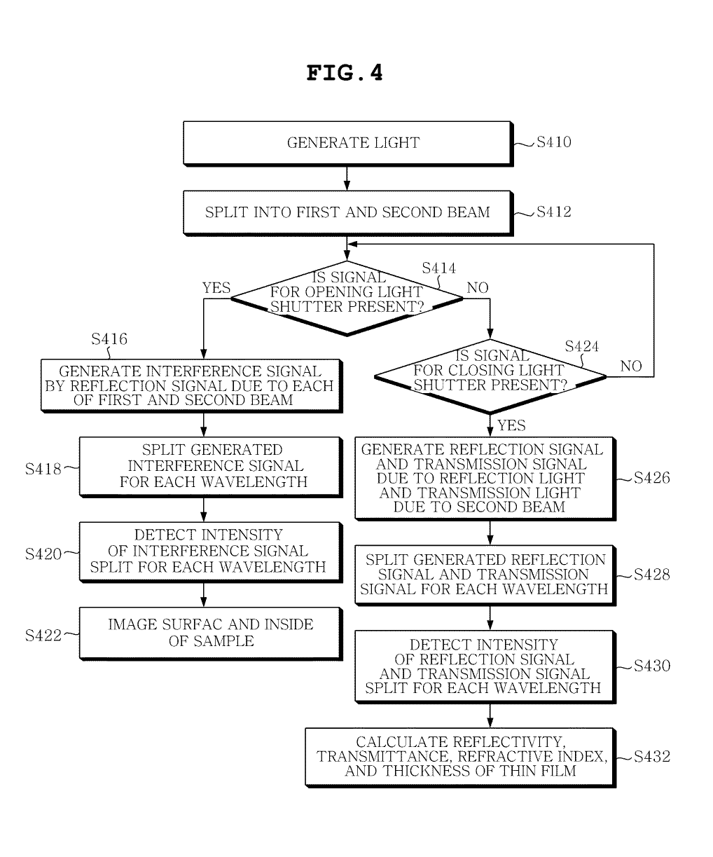

FIG. 4 is a flow chart showing a method for measuring characteristics of multi-layered thin films according to an exemplary embodiment of the present invention.

Referring to FIG. 4, the light source 110 of the light source member 100 is turned-on to generate light irradiated to the sample (S410).

The light generated from the light source member 100 is incident to the light splitting unit 210 and the incident light is split into the first beam moving to the reference light reflection unit 250 and the second beam moving to the sample, respectively (S412).

In this case, since the interference signal and the reflection signal are generated according to the signal controlling the opening and closing of the light shutter 230, that is, the opening and closing of the light shutter 230, it is first determined whether the control signal for opening the light shutter 230 is present (S414) and if so, it proceeds to a step (S416).

At step S414, if it is determined that the control signal for opening the light shutter 230 is not present, it is determined that the control signal for closing the light shutter 324 is present (S424) and if so, it proceeds to a step S426.

At step S424, if it is determined that the control signal for closing the light shutter 230 is not present, it proceeds to step S414 and the following process is repeated.

Meanwhile, at step S414, when the light shutter 230 is opened due to the presence of the control signal for opening the light shutter 230, the reference reflection light reflected from the reference light reflection unit 250 due to the first beam and the sample reflection light reflected from the sample due to the second beam overlaps in the light splitting unit 210, thereby generating the interference signal (S416).

Next, the generated interference signal is split for each wavelength through the first wavelength splitting unit 410 (S418) and the intensity of the interference signal split for each wavelength is detected (S420).

The surface and inside of the sample are imaged by performing Fourier transform on the detected intensity of the interference signal for each wavelength (S422).

Further, at step S424, when the light shutter 230 is closed due to the presence of the signal for closing the light shutter 230, the reference reflection light reflected from the reference light reflection unit 250 due to the first beam is not generated, such that the reflection signal is generated in the light splitting unit 210 by only the sample reflection light reflected from the sample due to the second beam and the transmission signal is generated by the light partially transmitting the sample due to the second beam (S426).

The generated reflection signal is split for each wavelength through the first wavelength splitting unit 410 and the transmission signal is split for each wavelength through the second wavelength splitting unit 510 (S428).

Next, the intensity of the reflection signal split for each wavelength is detected through the first photodetection unit 430 and the intensity of the transmission signal split for each wavelength is detected through the second photodetection unit 530 (S430).

The reflectivity for each wavelength and the transmittance for each wavelength are each acquired from the detected intensity of the reflection signal and the transmission signal for each wavelength and the acquired reflectivity and transmittance for each wavelength is applied to the Fresnel equations to calculate the refractive index for each wavelength and calculates the thickness of each layer of the multi-layered thin films according to a predetermined equation (for example, equation 1) representing the dispersion relationship of the wavelength and the refractive index by using the refractive index for each wavelength (S432).

As set forth above, the internal image, the reflectivity, the transmittance, the refractive index, and the thickness of the measured object formed of the multi-layered thin films can be measured nondestructively by the apparatus and method for measuring characteristics of multi-layered thin films.

The apparatus and method for nondestructively measuring characteristics of multi-layered thin films can be applied to a touch screen panel formed of a transparent thin film, a flexible polymer thin film product (for example, electronic paper, or the like), an optical lens module for an IT device, a wafer lens made of a multi-layered silicon, and application products.

In addition, the exemplary embodiment of the present invention controls the opening and closing of the light shutter 230 to use the reflection signal from the sample as well as the interference signal due to the overlapping of the reflection signal and the light reflected from the reference light reflection unit 250, thereby making it possible to measure the place of depth in the multi-layered thin films and the thickness of the thin film (for example, several tens of nm).

Further, the sample loading unit 330 in which the sample is loaded can be moved through the sample transfer unit 350, such that it is very easy to match and detect the measurement position, the structural information of the measurement position, and the optical characteristics of the measurement position (for example, reflectivity, transmittance, refractive index), thereby making it possible to increase the working efficiency.

As set forth above, the exemplary embodiment of the present invention provides the interference signals and the reflection signals according to the opening and closing of the light shutter, thereby making it possible to improve the measurement performance of characteristics of the multi-layered thin films as the nondestructive method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An apparatus for measuring characteristics of multi-layered thin films, comprising:
a light source member irradiating light to a sample formed of the multi-layered thin films;
an interference-reflection member installed on an optical path between the light source member and the sample to split light into a first beam for acquiring reference reflection light and a second beam for acquiring sample reflection light and generating an interference signal due to the overlapping of the reference reflection light reflected from the first beam and the sample reflection light reflected from the second beam when a light shutter is opened and generating the reflection signal due to the sample reflection light from the second beam when the light shutter is closed;
a sample member scanning and irradiating the sample so that the second beam is irradiated to the entire sample and transferring a support to which the sample is fixed so that the sample position is changed;
an interference-reflection light detection member splitting and detecting the intensity of the generated interference signal and reflection signal for each wavelength; and
a signal processing member using the intensity of the interference signal for each wavelength and the reflection signal for each wavelength detected from the interference-reflection detection unit to image the multi-layered thin films of the sample, calculating the reflectivity for each wavelength, the refractive index for each wavelength, and the thickness of each layer of the multi-layered thin films, and controlling the opening and closing of the light shutter and the transfer of the support.

2. The apparatus for measuring characteristics of multi-layered thin films as set forth in claim 1, wherein the light source member is a low coherence light source that is at least one of an (SLD), a femtosecond laser, an ASE, a fiber laser, supercontinuum lighting, and a lamp.

3. The apparatus for measuring characteristics of multi-layered thin films as set forth in claim 1, wherein the interference-reflection member includes:
a light splitting unit splitting light into the first beam and the second beam;
a reference light reflection unit reflecting reference reflection light by receiving the split first beam; and
a light shutter opened and closed to permit and interrupt the incidence and the reflection of the split first beam.

4. The apparatus for measuring characteristics of multi-layered thin films as set forth in claim 3, wherein the optical splitting unit is a beam splitter.

5. The apparatus for measuring characteristics of multi-layered thin films as set forth in claim 3, wherein the reference light reflection unit is a mirror.

6. The apparatus for measuring characteristics of multi-layered thin films as set forth in claim 1, wherein the sample member includes:
a sample scan unit scanning to be irradiated the second beam to the entire sample;
a sample loading unit including a sample irradiated with the second beam by the sample scan unit and a support fixed with the sample and movably designed to change the position of the sample; and
a sample transfer unit installed at one side of the support and operated to transfer the support up and down, left and right, and in a rotatable manner according to the control of the signal processing member.

7. The apparatus for measuring characteristics of multi-layered thin films as set forth in claim 6, wherein the sample scan unit is configured of a galvanometer mirror that one-dimensionally and two-dimensionally scans the second beam to the sample while repeatedly rotating by a predetermined angle according to a voltage value input by a first mirror and a second mirror using different axes as a rotating axis.

8. The apparatus for measuring characteristics of multi-layered thin films as set forth in claim 1, wherein the interference-reflection light detection member includes:
a first wavelength splitting unit splitting the intensity of the interference signal and the reflection signal for each wavelength; and
a first photodetection unit detecting the intensity of the interference signal for each wavelength and the reflection signal for each wavelength split by the first wavelength splitting unit.

9. The apparatus for measuring characteristics of multi-layered thin films as set forth in claim 8, wherein the first photodetection unit is any one of CCD, PMT, and PIN detectors.

10. The apparatus for measuring characteristics of multi-layered thin films as set forth in claim 1, wherein the signal processing member includes:
an optical signal processing unit converting the interference signal for each wavelength and the reflection signal for each wavelength detected from the interference-reflection light detection member into an electrical signal;
an image/calculation unit performing Fourier transform on the intensity of the converted interference signal for each wavelength to acquire the image of the multi-layered thin films of the sample and acquiring the reflectivity from a graph according to the intensity of the converted reflection signal for each wavelength to calculate the refractive index and the thickness of the multi-layered thin film of the sample; and
a transfer control unit controlling the opening and closing of the light shutter and controlling the transfer of the support to change the position of the sample.

11. The apparatus for measuring characteristics of multi-layered thin films as set forth in claim 1, further comprising a transmission light detection member splitting and detecting the intensity of the transmission signal for each wavelength, the transmission signal being generated by passing the second beam through the sample.

12. The apparatus for measuring characteristics of multi-layered thin films as set forth in claim 11, wherein the transmission light detection member includes:
a second wavelength splitting unit splitting the intensity of the transmission signal for each wavelength; and
a second photodetection unit detecting the intensity of the transmission signal for each wavelength split by the second wavelength splitting unit.

13. The apparatus for measuring characteristics of multi-layered thin films as set forth in claim 12, wherein the second photodetection unit is any one of CCD, PMT, and PIN detectors.

14. A method for measuring characteristics of multi-layered thin films, comprising:
(A) generating light for irradiating light to a sample configured of multi-layered thin films and splitting the generated light into a first beam for acquiring reference reflection light and a second beam for acquiring sample reflection light
(B) splitting and detecting the intensity of an interference signal and a reflection signal for each wavelength by determining whether a control signal for opening a light shutter is present to generate the interference signal due to the overlapping of the reference reflection light reflected from the first beam and the sample reflection light reflected from the second beam when the control signal for opening the light shutter is present and if it is determined that the control signal for opening the light shutter is not present, determining whether a control signal for closing the light shutter is present to generate the reflection signal by the sample reflection light due to the second beam; and
(C) acquiring images of the multi-layered thin films of the sample by using the detected intensity of the interference signal for each wavelength and calculating reflectivity, refractive index, and the thickness of the multi-layered thin films of the sample using the detected intensity of the reflection signal for each wavelength.

15. The method for measuring characteristics of multi-layered thin films as set forth in claim 14, wherein the step (A) includes:
(A-1) generating light for irradiating light to the sample;
(A-2) splitting the generated light into the first beam for acquiring the reference reflection light and the second beam for acquiring the sample reflection light.

16. The method for measuring characteristics of multi-layered thin films as set forth in claim 14, wherein the step (B) includes:
(B-1) determining whether the control signal for opening the light shutter is present;
(B-2) if it is determined that the control signal for opening the light shutter is not present, determining whether the control signal for closing the light shutter is present;
(B-3) if it is determined that the control signal for opening the light shutter is present, generating the interference signal due to the overlapping of the reference reflection light reflected from the first beam and the sample reflection light reflected from the second beam;
(B-4) if it is determined that the control signal for closing the light shutter is present, generating the reflection signal by the sample reflection light due to the second beam; and
(B-5) splitting and detecting the intensity of the generated interference signal and reflection signal for each wavelength.

17. The method for measuring characteristics of multi-layered thin films as set forth in claim 14, wherein the step (C) includes:
(C-1) performing Fourier transform on the detected intensity of the interference signal for each wavelength to acquire the image of the multi-layer thin films of the sample; and
(C-2) acquiring the reflectivity for each wavelength through a graph according to the detected intensity of the reflection signal for each wavelength and applying the acquired reflectivity for each wavelength to Fresnel equations to calculate the refractive index for each wavelength, and calculating the thickness of each layer of the multi-layered thin films of the sample according to a dispersion relationship of the wavelength and the refractive index by using the calculated refractive index for each wavelength.

18. The method for measuring characteristics of multi-layered thin films as set forth in claim 14, further comprising:
(D) acquiring transmittance by splitting and detecting the intensity of the transmission signal for each wavelength, the transmission signal being generated by passing the second beam through the sample.

19. The method for measuring characteristics of multi-layered thin films as set forth in claim 18, wherein the step (D) includes:
(D-1) generating a transmission signal by transmission light generated by partially passing the second beam through the sample,
(D-2) splitting and detecting the intensity of the generated transmission signal for each wavelength; and
(D-3) acquiring the transmittance for each wavelength through a graph according to the detected transmission signal for each wavelength.
